(19) United States
(12) Patent Application Publication
(10) Pub. No.: US 2024/0170855 A1
(43) Pub. Date: May 23, 2024

(54) MULTI-BEAM MULTI-BAND ANTENNA ARRAY MODULE

(71) Applicant: Pavlo Anatoliyovich Molchanov, Las Cruces, NM (US)

(72) Inventor: Pavlo Anatoliyovich Molchanov, Las Cruces, NM (US)

(21) Appl. No.: 17/971,616

(22) Filed: Nov. 20, 2022

(51) Int. Cl. H01Q 21/08; H04B 1/38; H04B 7/04

(52) U.S. Cl. CPC H01Q 21/08; H04B 1/38; H04B 7/04

(57) ABSTRACT

Array of non-switchable non-scanning directional antennas combined to module with covering wide area of observation and simultaneous continuous illumination or receiving reflected signals from multiple targets, wherein antenna patterns are overlapping in as minimum one direction to form monopulse subarrays. Monopulse subarrays provides one iteration direction finding and references for automatic gain control and adaptation to transferring media. Each directional antenna coupled with separate transmitting/receiving means which providing continuous fast simultaneous multi-directional multi-band signals processing with high data rate. Non-scanning directional antennas do not need frequency dependent beamforming phase processor and provides continuous automatically controlled high gain in all channels independently and simultaneously.

Nowadays customers of ground base portable communication systems looking for one antenna that can receive SATCOM signals from constellations in LEO, MEO and GEO. To solve the LEO antenna problem some companies are proposing an electronically steerable antennas, flat panel antenna based on open standards that eliminates the need for two parabolic antennas for LEO constellations. In effect, it automatically cycles to track a LEO sat, but electronically steerable phase array flat panel antennas cannot receive signals as it crosses the horizon, and as those satellites dips out of sight. It need be moving by motors or switch to another panel steerable antenna panel to receive the signal from another beam focused on the rising satellite. Electronically steerable means phase array panel antenna. But phase directly connected with frequency and array physically cannot be wideband or multi-frequency. Trade between frequency band, gain and switching antenna elements (Prior ART FIG. 1, U.S. Pat. No. 9,831,548 B1) or channel active time leads to loos signal and/or data rate. Panel phase array antennas need to use moving parts, for example motor to change direction segment. Multi-beam antennas with concave or convex edge of dielectric substrate (PRIOR ART FIG. 2, US 2005/0219126 A1) can exclude moving parts for entire sky observation, but need separate cannels control, can provide only limited frequency bandwidth and separate channels “looking” for separate sectors cannot be adapted to varying signals transferring media parameters.

Passive Multibeam Antennas for Broadband Wireless Communication proposed in [1,2] requiring large size beamforming matrix system (Prior ART FIG. 3) and frequency dependent. Phase array scattering approx. 80% of transmitting power to air because control of transmitting signals phase only without switching direction in separate antenna element does not mean control of direction of entire phase array, because every antenna element transmitting energy omnidirectionally.

### BACKGROUND OF THE INVENTION

Present invention related to multi-antenna system, i.e., transmission or reception using two or more spaced independent antennas with different the orientation and the shape of the directional pattern of the waves radiated from an antenna or antenna system. More particular to arrangements associated with antennas, structural form of radiating and receiving antenna elements.

Multi-beam antenna system for cellular radio base station presented by Ward Christopher Robert, Smith Martin Stevens, and Jeffers Andrew William in EP 0 883 208 B1 patent “Multi-beam antenna system for cellular radio base stations”. Antenna arrangement comprises a compact aperture multi-element main antenna array capable of discriminating transmitted signals within a plurality of receive beam zones occupying a sector area, received antenna signals from the main antenna array being fed through a beam former matrix having a plurality of signal output ports, each signal output port outputting a beam signal received from a corresponding beam zone; a diverse antenna capable of receiving signals over a whole of the sector; a diversity receiver receiving an output signal from the main antenna array and the diverse antenna, and operating to compare the two received signals and either select the strongest signal of those output from the main antenna array or the diverse antenna, or operating to combine the signals of the main antenna array and diverse antenna array; a switch control operating to switch an output of the beam former corresponding to one of the said plurality of beams to the diversity receiver; and a beam locate receiver operating to scan each of the outputs of the beam former for locating an output on which a received signal is present, corresponding to a signal received within a beam zone of one of the plurality of receive beams of the main antenna array. The beam locate receiver determines the best beam for receiving a signal from a mobile station within a sector using waveform discrimination to distinguish wanted from unwanted signals and provides a switching signal to the switch control which routes an output beam signal of the beam former corresponding to the best beam for receiving communications channel signals from the mobile station through to the diversity receiver. But this multi-beam antenna formed by a few omnidirectional antennas switched in different configurations.

All activated antennas still transmitting electromagnetic energy to all directions same time. Change phases in antennas allows to sum transmitting energy in some determined direction, but most part of transmitting energy and transmitting signals still be transmitting everywhere.

Multi-beam antenna presented in patent US 2005/0219126 A1 “Multi-beam antenna” by Gabriel M. Rebeiz consists plurality of antenna elements on a dielectric substrate which are adapted to launch or receive electromagnetic waves in or from a direction substantially away from either a convex or concave edge of the dielectric substrate, wherein at least two of the antenna elements operate in different directions. Slot lines of tapered-slot end fire antennas in a first conductive layer of a first side of the dielectric substrate are coupled to microstrip lines of a second conductive layer on the second side of the dielectric substrate. A bi-conical reflector, conformal cylindrical dielectric lens, or planar lens improves the H-plane radiation pattern. Dipole or Yagi-Uda antenna elements on the conductive layer of the dielectric substrate can be used in cooperation with associated reflective elements, either alone or in combination with a corner-reflector of conductive plates attached to the conductive layers proximate to the end fire antenna elements.

Antenna elements in this array forming directional antennas, for launch or receive electromagnetic waves in or from a different direction substantially away from either a convex or concave edge of dielectric substrate. Signals in each separate antenna can be variable depends on receiving from outside signals or change of parameters of signals transferring media. Reference signals would be helpful for separation useful signals and transferring media influence.

John Howard proposed “Polypod Antenna” (U.S. Pat. No. 8,170,634 B2). The antennas are configured to transmit a first electromagnetic signal at full power via a first set of radiating elements and to transmit the first electromagnetic signal at an attenuated power via a second set of radiating elements to decrease side lobes associated with the transmission of the first electromagnetic signal. The antennas are configured to receive a second electromagnetic signal having an associated first power level via the second set of radiating elements and to form an aggregated electromagnetic signal having a second power level that is a multiple of the first power level. The antennas are configured to attenuate the aggregated signal to form an attenuated electromagnetic signal having a third power level to facilitate uniform reception of the second electromagnetic signal and tapered transmission.

This type of commercial multibeam wireless phased array antenna systems are requiring beamforming and beam shaping networks, which increasing mass and cost of system.

Phase array scattering approx. 80% of transmitting power to air because control of transmitting signals phase only without switching direction in separate antenna element does not mean control of direction of entire phase array, because every antenna element transmitting energy omnidirectionally. Antenna elements forming phase array must have as possible wide angle of view, means be omnidirectional. Efficiency of four beams antenna system too small because gain of each antenna formed beam four times smaller than possible corresponding to antenna array aperture. Gain of each beam equal to maximum possible gain divided to number of beams for omni-directional antenna elements.

Such multi-beam antenna array can provide up to 96 dual-polarized beams/sectors in 360° azimuth but only approx. 120 degrees by elevation because plane panel surface.

Fixed beams and fixed beams directions do not allow electronic adjustment if need to actively adjust beam/sector position.

True antenna system capacity multiplied by number of beams, but limited by frequency bands because electronic scanning system, or phase array is frequency dependent. Phase directly connected to frequency and bandwidth can be extended by trade with gain, direction limit and switching active time only.

Fixed beams with fixed direction cannot provide adaptation of signal to noise ratio without reference channel. Fixed beams cannot be focused and extend the range of network.

Array of directional antennas with overlap antenna patterns and multi-channel signal's processing provides higher direction-finding accuracy, direction adjustment possibility and faster signals processing Stephen E. Lipsky [3].

Fly Eye antenna system described in [4] by Pavlo A. Molchanov can provide 360-degree coverage by azimuth and elevation, continuous higher gain and capacity in each channel, one-step direction adjustment and adaptation to transferring media and multi-band work limited by directional antenna bandwidth only.

An objective of the present invention is development fast multi-beam multi-band antenna array module. Array consisting of non-switchable non-scanning directional antennas combined to module with wide covering area wherein antenna patterns are overlapping in as minimum one direction to form monopulse subarrays. Each directional antenna coupled with separate transmitting/receiving means and providing simultaneous multi-directional multi-band signals fast processing with high data rate. Distributed non-scanning directional antennas do not need frequency dependent beamforming phase processor and providing continuous high gain in all channels independently and simultaneously. Number of channels equal to number of antennas and providing large antenna module capacity.

Multi-beam antenna array arranged as modules consisting of plurality of antenna elements which forming directional antennas. Plurality of multi-beam antenna array modules simultaneous covering entire sky or area of observation wherein each separate module covering subdivided space sector by said directional antennas. Antenna patterns of said directional antennas overlap in one or more directions for creating monopulse subarrays continuously covering subdivided sector of entire sky or area of observation. Each multi-beam antenna array module comprising of monopulse processor for simultaneous multi-axis processing of all signals in receiving chains as ratio of amplitudes and/or phase shift of signals to decrease pointing error and one-iteration adapting to decrease media influence to receiving chain parameters by phase shift in set of neighboring directional antennas with overlap antenna patterns. Each directional antenna coupled with separate transceiver channel consisting of transmitting chain and receiving chain with signal conditioning circuit including voltage or current limiters, anti-aliasing circuits, analog-to-digital converters and connected by digital interface to signal processor and feed network. Feed network connected by digital interface arranged as universal serial bus (USB) or microwave and/or fiber optic waveguides to signal processor with memory for storing executable instructions and for separate processing of amplitudes, phases, frequency components shift of signals in transmitting and receiving chains. Plurality of multi-beam antenna array modules can be distributed by some order on carrier/satellite, vehicle or distributed between swarm or constellation of carriers/satellites to cover entire sky or area of observation. All transmitters, receiver chains, monopulse processor and signal processor connected with synchronization means by digital interface.

In first embodiment multi-beam antenna array module of consisting transmitting and receiving circuits and signal processor are arranged for simultaneous transmitting, receiving, and processing signals on a few different frequencies (multi-frequency signals) and comprising corresponding arranged directional antennas, anti-aliasing circuits and filtering means in each transmitter and receiving chain.

In second embodiment multi-beam antenna array module consisting transmitting and receiving circuits and signal processor are arranged for simultaneous transmitting, receiving, and processing different modes signals, such as communication, navigation, control (multi-mode, multi-function signals) and comprising corresponding arranged directional antennas, anti-aliasing circuits and filtering means in each transmitter and receiving chain.

### BRIEF DESCRIPTION OF DRAWINGS

PRIOR ART FIG. 1 illustrates of the multi-beam antenna system consisting directional antennas with beam switchers and beam forming blocks.

PRIOR ART FIG. 2 shows known multi-beam antenna with plurality of antenna elements operate in different directions.

PRIOR ART FIG. 3 shows polypod antenna comprising plurality of antenna elements and beam forming block.

FIG. 1 illustrates first and second embodiments of multi-beam plane antenna array module.

FIG. 2 illustrates how multi-beam antenna array covering entire sky wherein separate modules covering subdivided sectors.

FIG. 3 illustrates how antenna patterns of directional antennas in module can overlap in two-axis directions FIG. 3(a) and three-axis directions FIG. 3(b).

FIG. 4 shows first embodiment of multi-beam transceiver module with analog monopulse processor.

FIG. 5 shows second embodiment of multi-beam transceiver module with software defined radios and monopulse processor imbedded in signal processor.

FIG. 6 shows multi-beam transceiver module arranged with separate transmitter.

FIG. 7 shows multi-beam transceiver modules arranged as slat armor distributed around vehicle perimeter.

FIG. 8 shows multi-beam transceiver modules arranged for indoor and outdoor applications.

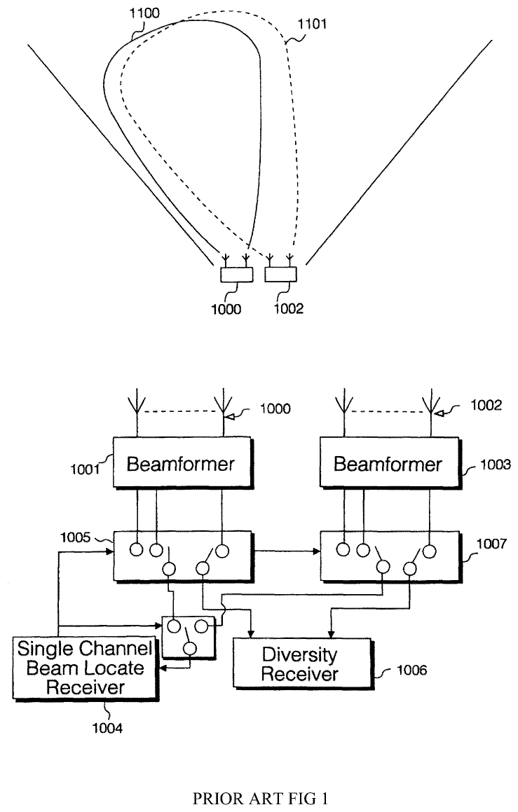

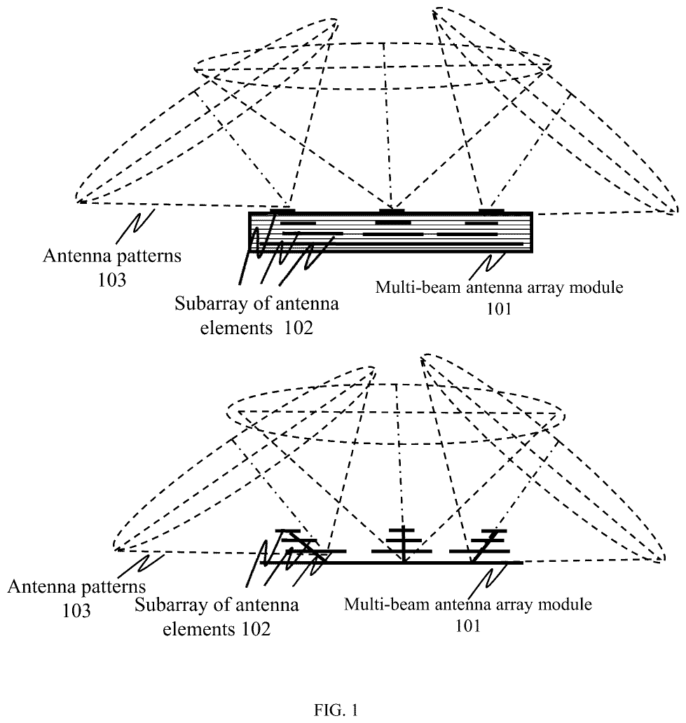

First embodiment and second embodiments of multi-beam antenna array module illustrated in FIG. 1. Module 101 comprising array of directional antennas 102 distributed inside module volume. In first embodiment shown in FIG. 1 (a) multi-beam antenna array arranged as plurality of antenna elements 102 which forming directional antennas with overlap antenna patterns 103. Antenna elements may be positioned in some order to form directional antennas inside the dielectric with constant or variable inside substrate dielectric constant, or as 3D metamaterial substrate as shown in (FIG. 1(a). In second embodiment shown in FIG. 1 (b) multi-beam antenna array 101 arranged as plurality of directional antennas 102 with overlap antenna patterns 103. Directional antennas can be arranged inside dielectric substrates attached to main substrate.

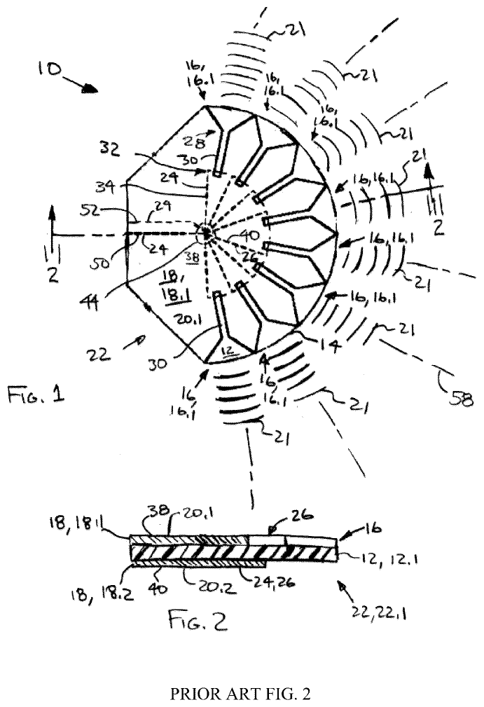

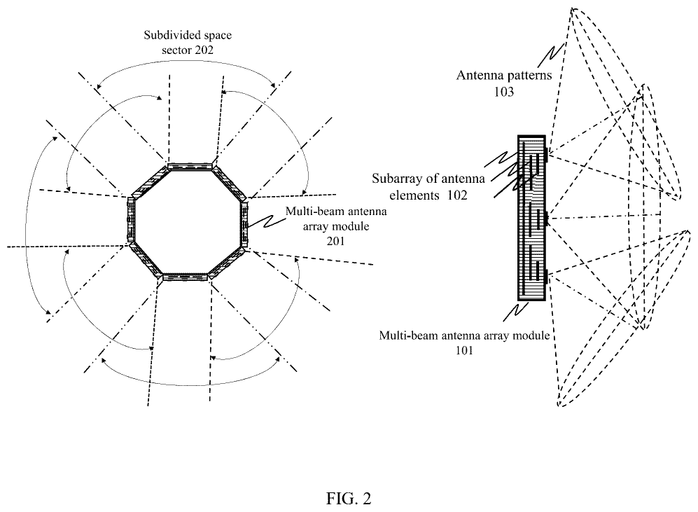

FIG. 2 illustrates how multi-beam antenna array can cover entire sky wherein separate modules covering subdivided sectors. Plurality of multi-beam antenna array modules 202 simultaneous covering entire sky or area of observation wherein each separate module 201 covering subdivided space sector 202 by said directional antennas.

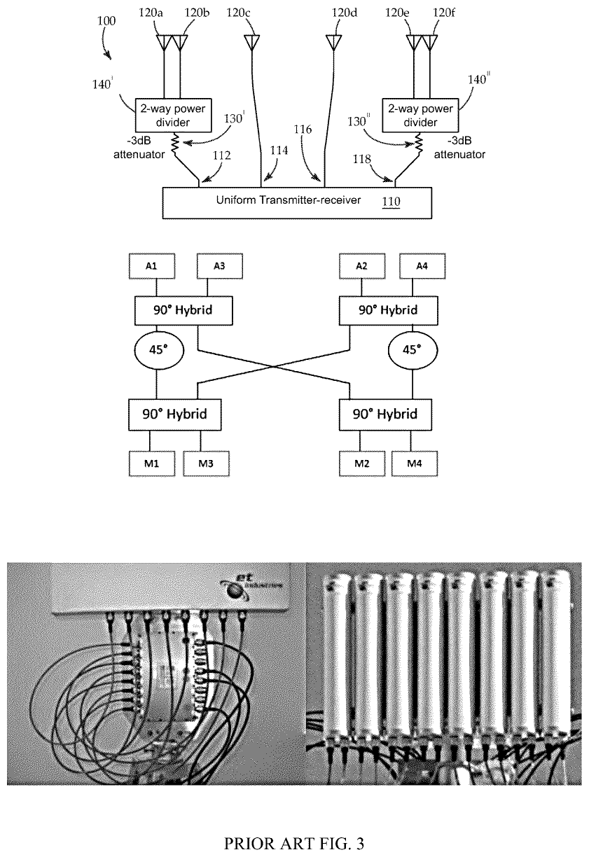

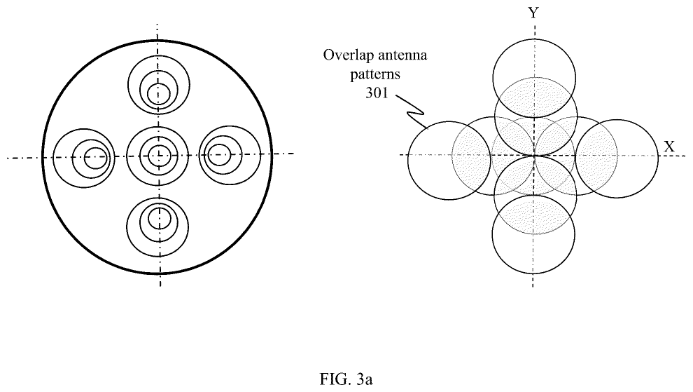

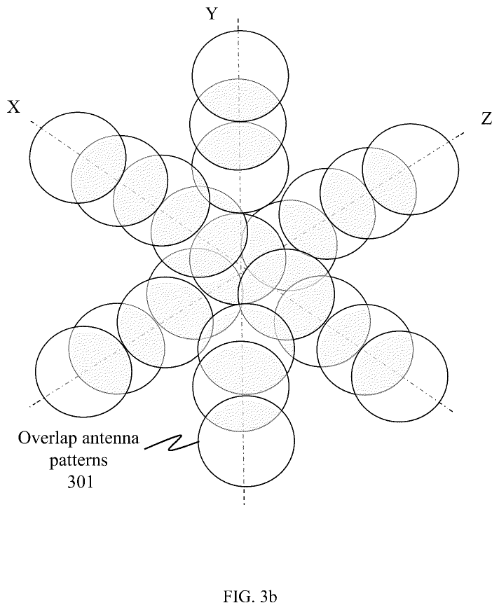

Antenna patterns of said directional antennas overlap in one or more directions for creating monopulse subarrays continuously covering subdivided sector of entire sky or area of observation. FIG. 3 illustrates how antenna patterns of directional antennas 301 in module can overlap in two-axis X, Y directions FIG. 3(a) and three-axis directions X, Y, Z FIG. 3(b).

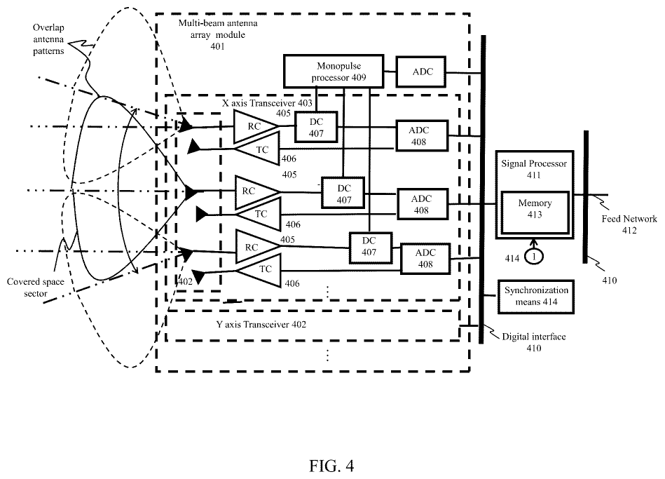

First embodiment of multi-beam transceiver module with analog monopulse processor presented in FIG. 4. Each multi-beam transceiver module 401 comprising plurality of overlap directional antennas 402 coupled with transceivers arranged in different axis, for example X-axis transceivers 403, Y-axis transceiver 404, as shown in FIG. 4. Each directional antenna 402 coupled with separate transceiver channel consisting of receiving chain 405 and transmitting chain 406 with signal conditioning circuit including voltage or current limiters, anti-aliasing circuits, directional coupler 407 and software defined radio 408 (SDR) consisting analog-to-digital converters.

Each transceiver module also comprising analog monopulse processor 409 coupled by directional couplers to each receiving channels 405 for simultaneous multi-axis processing of receiving signals as ratio of amplitudes and/or phase shift of signals to decrease pointing error and one-iteration adapting to decrease media influence to receiving chain parameters by phase shift in set of neighboring directional antennas with overlap antenna patterns.

All transceiver channels connected by digital interface 410 to signal processor 411 and feed network 412. Feed network 412 connected by digital interface 410 arranged as universal serial bus (USB) or microwave and/or fiber optic waveguides to signal processor 411 with memory 413 for storing executable instructions and for separate processing of amplitudes, phases, frequency components shift of signals in transmitting and receiving chains. All transmitting, receiver chains, monopulse processor 409 and signal processor 411 are connected with synchronization means 414 by digital interface 410.

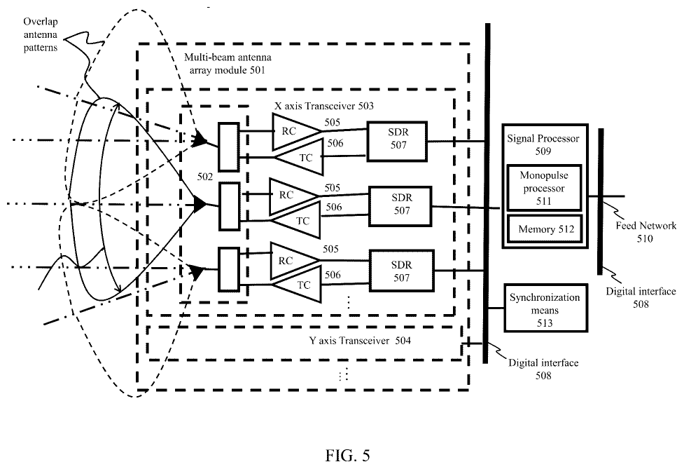

Second embodiment of multi-beam transceiver module with digital monopulse processor presented in FIG. 5. Each multi-beam transceiver module 501 comprising plurality of overlap directional antennas 502 coupled with transceivers arranged in different axis, for example X-axis transceivers 503, Y-axis transceiver 504, as shown in FIG. 5. Each directional antenna 502 coupled with separate transceiver channel consisting of receiving chain 505 and transmitting chain 506 with signal conditioning circuit including voltage or current limiters, anti-aliasing circuits, and software defined radio 407 (SDR) consisting analog-to-digital converters and connected by digital interface 508 to signal processor 509 and feed network 510.

Signal processor 509 consisting monopulse processor 511 for simultaneous multi-axis processing of all receiving signals as ratio of amplitudes and/or phase shift of signals to decrease pointing error and one-iteration adapting to decrease media influence to receiving chain parameters by phase shift in set of neighboring directional antennas with overlap antenna patterns.

Feed network 510 connected by digital interface 508 arranged as universal serial bus (USB) or microwave and/or fiber optic waveguides to signal processor 509 with memory 512 for storing executable instructions and for separate processing of amplitudes, phases, frequency components shift of signals in transmitting and receiving chains. All transmitting, receiver chains and signal processor 509 are connected with synchronization means 513 by digital interface 508.

Plurality of multi-beam antenna array modules can be distributed by some order on carrier/satellite, vehicle or distributed between swarm or constellation of carriers/satellites to cover entire sky or area of observation.

Multi-beam antenna array module consisting transmitting and receiving chains and signal processor can be arranged for simultaneous transmitting, receiving, and processing signals on a few different frequencies (multi-frequency signals) and comprising corresponding arranged directional antennas, anti-aliasing circuits and filtering means in each transmitter and receiving chain.

Multi-beam antenna array consisting of transmitting and receiving chains and signal processor can be arranged for simultaneous transmitting, receiving, and processing different modes signals, such as communication, navigation, control (multi-mode signals) and comprising corresponding arranged directional antennas, anti-aliasing circuits and filtering means in each transmitter and receiving chain.

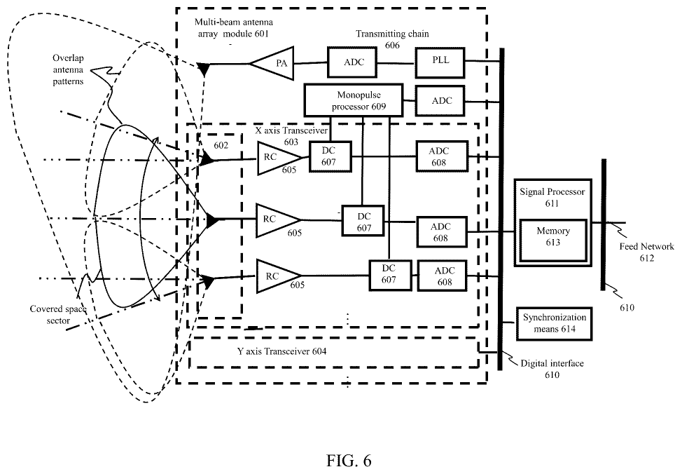

Third embodiment of multi-beam transceiver module with one transmitter covering space sector presented in FIG. 6. Each multi-beam transceiver module 601 comprising plurality of overlap directional antennas 602 coupled with transceivers arranged in different axis, for example X-axis transceivers 603, Y-axis transceiver 604, as shown in FIG. 6. Each directional antenna 602 consists separate transceiver channel consisting of receiving chain 605. Module consists one transmitting chain 606 Phase Lock Loop (PLL), analog-to digital amplifier ADC and power amplifier PA. Each directional antenna coupled with receiving channel 603 consisting signal conditioning including voltage or current limiters, anti-aliasing circuits, directed coupler 607, consisting analog-to-digital converter 608 and monopulse processor 609. Transmitting and receiving channels are connected by digital interface 610 to signal processor 611 and feed network 612.

Signal processor 611 consisting memory 613. Feed network 612 connected by digital interface 610 arranged as universal serial bus (USB) or microwave and/or fiber optic waveguides to signal processor 611 with memory 613 for storing executable instructions and for separate processing of amplitudes, phases, frequency components shift of signals in transmitting and receiving chains. All transmitting, receiver chains and signal processor 611 are connected with synchronization means 614 by digital interface 508.

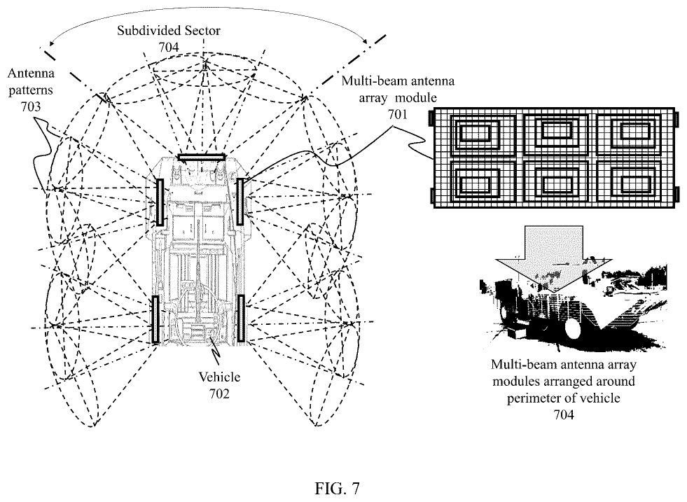

FIG. 7 shows modules wherein multi-beam antenna arrays arranged with transceiver for indoor and outdoor applications.

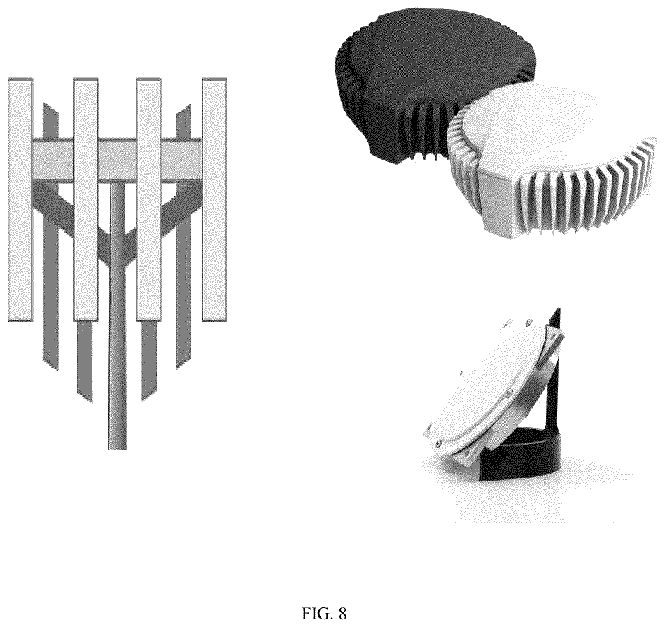

FIG. 8 shows multi-beam transceiver modules arranged as slat armor distributed around vehicle perimeter.

### REFERENCE NUMBERS

101—multi-beam antenna array module
102—antenna elements
103—antenna patterns
201—multi-beam antenna array module
202—subdivided space sector
301—overlap antenna patterns
401—multi-beam transceiver module
402—array of directional antennas
403—X-axis transceiver
404—Y-axis transceiver
405—receiving chain
406—transmitting chain
407—directional coupler
408—software defined radio
409—analog monopulse processor
410—digital interface
411—signal processor
412—feed network
413—memory
414—synchronization means
501—multi-beam transceiver module
502—array of directional antennas
503—X axis transceiver
504—Y axis transceiver
505—receiving chain
506—transmitting chain
507—software defined radio
508—digital interface
509—signal processor
510—feed network
511—monopulse processor
512—memory
513—synchronization means
601—multi-beam transceiver module
602—array of directional antennas
603—X axis transceiver
604—Y axis transceiver
605—receiving chain
606—transmitting chain
607—directional coupler
608—analog-to-digital converter
609—monopulse processor
610—digital interface
611—signal processor
612—feed network
613—memory
614—synchronization means
701—transceiver module
702—vehicle
703—antenna patterns
704—transceiver modules arranged around vehicle perimeter

### Operation

The plurality of directional antennas arranged inside multi-beam antenna array module continuous covering subdivided sector of entire area of observation. Subarray of neighboring directional antennas are overlapping in one-axes, quadrature or in multi-axes directions. Set of directional antennas with overlap antenna patterns allows automatic gain control in each receiving chain and use some antennas for reference for direction finding, direction correction and/or adaptation to transferring media parameters. Each directional antenna coupled with separate transceiver chain and can simultaneously use full channels capacitance for separate transmitting and receiving signals and non-interrupting work. Plurality of said directional antennas coupled with transceiver chains distributed by some order on vehicle or distributed between swarm or constellation of carriers/satellites to cover subdivided sector of area of observation same time provides better protection against high power electromagnetic pulse weapon or jamming signals. Each multi-beam antenna array module covering subdivided sector of entire area of observation comprising of monopulse processor for simultaneous multi-axis processing of all signals in receiving chains as ratio of amplitudes and/or phase shift of signals for adjustment signals to decrease pointing error to transmitter and one-iteration adapting to decrease media influence on communication channels parameters by phase shift in set of neighboring directional antennas. Each transceiver module comprising analog-to digital converters connected to signal processor with memory for storing executable instructions and for separate processing of amplitudes, phases, frequency components shift of signals in receiving chains and transmitters. Directional antennas coupled to separate receiving chains, transmitters and monopulse processor inside said multi-beam antenna array module are connected to signal processor by digital interface to transmit or receive communication signals by using universal serial bus (USB) or microwave and/or fiber optic waveguides. Each receiving channel consisting of signal conditioning circuit including voltage or current limiters, anti-aliasing circuits, and software defined radio (SDR), analog-to-digital converters and connected by digital interface to signal processor and feed network.

Synchronization means providing synchronization of all transmitters, receiver chains, monopulse processor and signal processor connected by digital interface.

The time of signals processing is significantly decreased because signals from all satellites and other communication nodes processing simultaneously, even compare to processing digitally by switching virtual beamforming receiving signals. For example, a scanning system typically processes only one beam at a time, holographic staring systems processes signals by switching virtual beams and monopulse system processing all beams simultaneously.

Also, holographic systems transmitting more powerful signals, since a scanning system contains a high gain antenna on both transmit and receive, and in monopulse system transmitting power spreading inside relative wide space sector. From another side, high gain antennas in monopulse systems provides better gain and sensitivity than holographic systems, where usually applied array of omnidirectional antennas, which need provide wide area of observation for each antenna array element, and virtual set of receiving signals antennas activated for very short time for one separate node. Practically monopulse system will provide same gain and sensitivity of antennas, as scanning system with similar directional antenna.

Monopulse systems can be continuous waves or pulsed [3].

Monopulse method provides better beam pointing accuracy of 2-3 orders then scanning systems. Synchronizing of signals directly in antennas provide high accuracy amplitude and phase measurement. Non scanning antenna array is phase/frequency independent and can be multi-frequency, multi-function. All receiving chains using ratio of amplitudes, phases and relative frequency components shift of signals for multi-axis signal processing. Monopulse processor can consist of filters and processing means for separation clutter signals, background noise, compensate moving errors.

1. Multi-beam antenna array comprising plurality of antenna elements coupled with at least one feed network wherein:
multi-beam antenna array arranged as modules consisting of plurality of antenna elements which forming directional antennas wherein antenna patterns of said directional antennas overlap in one or more directions for creating monopulse subarrays continuously covering subdivided sector of entire sky or area of observation;
each directional antenna formed by subarray of antenna elements arranged in module volume, on module surface or combined;
plurality of multi-beam antenna array modules simultaneous covering entire sky or area of observation wherein each separate module covering subdivided space sector by said directional antennas;
each directional antenna coupled with separate transceiver channel consisting of transmitting chain and receiving chain with signal conditioning circuit including voltage or current limiters, anti-aliasing circuits, analog-to-digital converters and connected by digital interface to signal processor and feed network;
each multi-beam antenna array module comprising of monopulse processor for simultaneous multi-axis processing of all signals in receiving chains as ratio of amplitudes and/or phase shift of signals for direction finding or to decrease pointing error and one-iteration adapting to decrease transferring media influence to receiving chain parameters by phase shift in subarray of neighboring directional antennas with overlap antenna patterns;
feed network connected by digital interface arranged as universal serial bus (USB) or microwave and/or fiber optic waveguides to signal processor with memory for storing executable instructions and for separate processing of amplitudes, phases, frequency components shift of signals in transmitting and receiving chains;
plurality of multi-beam antenna array modules can be distributed by some order on carrier/satellite, vehicle or distributed between swarm or constellation of carriers/satellites to cover entire sky or area of observation;
all transmitters, receiver chains, monopulse processor and signal processor connected with synchronization means by digital interface.

2. Multi-beam antenna array module of claim 1, wherein multi-beam antenna array arranged as concave, convex, cylindric full/hemi sphere modules consisting of plurality of antenna elements which forming directional antennas.

3. Multi-beam antenna array module of claim 1, wherein monopulse processor imbedded in signal processor and connected to feed network by digital interface.

4. Multi-beam antenna array module of claim 1, wherein transmitting and receiving circuits and signal processor are arranged for simultaneous transmitting, receiving, and processing signals on a few different frequencies (multi-frequency signals) and comprising corresponding arranged directional antennas, anti-aliasing circuits and filtering means in each transmitter and receiving chain.

5. Multi-beam antenna array module of claim 1, wherein transmitting and receiving circuits and signal processor are arranged for simultaneous transmitting, receiving, and processing different modes signals, such as communication, navigation, control (multi-mode, multi-function signals) and comprising corresponding arranged directional antennas, anti-aliasing circuits and filtering means in each transmitter and receiving chain.

6. Multi-beam antenna array module of claim 1, wherein receiving circuits and signal processor are arranged for simultaneous processing received signals for detection direction of arriving for jam and/or spoof signals and comprising corresponding arranged analog and digital filtering means in each receiving chain and signal processor.

7. Multi-beam antenna array comprising plurality of antenna elements coupled with at least one feed network wherein:
multi-beam antenna array arranged as modules consisting of plurality of antenna elements which forming directional antennas;
each directional antenna formed by subarray of antenna elements arranged in module volume, on module surface or combined;
plurality of multi-beam antenna array modules simultaneous covering entire sky or area of observation wherein each separate module covering subdivided space sector by said directional antennas;
each directional antenna coupled with separate software defined radio (SDR) via signal conditioning circuit including voltage or current limiters, anti-aliasing circuits and connected by digital interface to signal processor and feed network;
antenna patterns of said directional antennas overlap in one or more directions for creating monopulse subarrays continuously covering subdivided sector of entire sky or area of observation;
said signal processor comprising of monopulse processor for simultaneous multi-axis processing of all signals in receiving chains as ratio of amplitudes and/or phase shift of signals relative to signals in reference receiving chain for direction finding or to decrease pointing error and one-iteration adapting to decrease transferring media influence to receiving chain parameters by phase shift in subarray of neighboring directional antennas with overlap antenna patterns;
feed network connected by digital interface arranged as universal serial bus (USB) or microwave and/or fiber optic waveguides to signal processor with memory for storing executable instructions and for separate processing of amplitudes, phases, frequency components shift of signals in transmitting and receiving chains;
plurality of multi-beam antenna array modules can be distributed by some order on carrier/satellite, vehicle or distributed between swarm or constellation of carriers/satellites to cover entire sky or area of observation;
all software defined radios and signal processor connected with synchronization means by digital interface.
